(19) United States
(12) Patent Application Publication
(10) Pub. No.: US 2019/0139120 A1
(43) Pub. Date: May 9, 2019

(54) IDENTIFICATION OF APPAREL BASED ON USER CHARACTERISTICS

(71) Applicant: International Business Machines Corporation

(72) Inventors: Priyanka Agrawal, Bangalore (IN); Ayushi Dalmia, Kolkata (IN); Sachindra Joshi, Gurgaon (IN); Vikas Chandrakant Raykar, Bangalore (IN); Raghavendra Singh, New Delhi (IN)

(21) Appl. No.: 16/201,789

(22) Filed: Nov. 27, 2018

Related U.S. Application Data
(63) Continuation-in-part of application No. 15/648,076, filed on Jul. 12, 2017, now abandoned.

(51) Int. Cl. G06Q 30/06; G06Q 30/02; G06Q 50/00; G06K 9/20; G06K 9/32; G06F 17/27

(52) U.S. Cl. CPC G06Q 30/0631; G06Q 30/0282; G06Q 50/01; G06F 17/2705; G06K 9/3241; G06K 9/3216; G06K 9/2054

(57) ABSTRACT

One embodiment provides a method, including: utilizing at least one processor to execute computer code that performs the steps of: obtaining at least one image of a user of a social medium from one or more posts on the social medium that are shared by the user; identifying a characteristic of the user by comparing characteristics of the at least one image of the user to other persons, wherein the other persons are clustered into characteristic groups based upon one or more images of each of the other persons; determining attributes of apparel included in the images of each of the other persons by parsing the one or more images and any text associated with the images of each of the other persons; and generating apparel style rules for a particular characteristic by associating the determined attributes of the apparel with the identified characteristic. Other aspects are described and claimed.

### CROSS REFERENCE TO RELATED APPLICATIONS

This application is a continuation-in-part application of U.S. patent application Ser. No. 15/648,076, filed on Jul. 12, 2017, the contents of which are incorporated by reference herein.

### BACKGROUND

Shopping for apparel (e.g., clothes, purses, hats, accessories, shoes, etc.) is a general necessity. For some people, shopping for apparel may be a hobby, or function as a social outing, a time to relax, or the like. For example, some people shop like to shop with friends. Many people shop for apparel in physical stores because the shopper prefers to try on the item, feel the item, etc. Additionally, in a physical store, sales associates may assist a shopper in finding apparel that suits the shopper, for example, in a flattering color, shape, or fabric. However, shopping online for apparel is also very common for various reasons, for example, some people do not like to shop, some people do not have the time to go to a physical store, a physical store may not be near the shopper, a person may prefer the selection of a virtual store as opposed to a physical store, and so on.

### BRIEF SUMMARY

In summary, one aspect of the invention provides a method, comprising: utilizing at least one processor to execute computer code that performs the steps of: obtaining at least one image of a user of a social medium from one or more posts on the social medium that are shared by the user; identifying a characteristic of the user by comparing characteristics of the at least one image of the user to other persons, wherein the other persons are clustered into characteristic groups based upon one or more images of each of the other persons; determining attributes of apparel included in the images of each of the other persons by parsing the one or more images and any text associated with the images of each of the other persons; and generating apparel style rules for a particular characteristic by associating the determined attributes of the apparel with the identified characteristic.

Another aspect of the invention provides an apparatus, comprising: at least one processor; and a computer readable storage medium having computer readable program code embodied therewith and executable by the at least one processor, the computer readable program code comprising: computer readable program code that obtains at least one image of a user of a social medium from one or more posts on the social medium that are shared by the user; computer readable program code that identifies a characteristic of the user by comparing characteristics of the at least one image of the user to other persons, wherein the other persons are clustered into characteristic groups based upon one or more images of each of the other persons; computer readable program code that determines attributes of apparel included in the images of each of the other persons by parsing the one or more images and any text associated with the images of each of the other persons; and computer readable program code that generates apparel style rules for a particular characteristic by associating the determined attributes of the apparel with the identified characteristic.

An additional aspect of the invention provides a computer program product, comprising: a computer readable storage medium having computer readable program code embodied therewith, the computer readable program code executable by a processor and comprising: computer readable program code that obtains at least one image of a user of a social medium from one or more posts on the social medium that are shared by the user; computer readable program code that identifies a characteristic of the user by comparing characteristics of the at least one image of the user to other persons, wherein the other persons are clustered into characteristic groups based upon one or more images of each of the other persons; computer readable program code that determines attributes of apparel included in the images of each of the other persons by parsing the one or more images and any text associated with the images of each of the other persons; and computer readable program code that generates apparel style rules for a particular characteristic by associating the determined attributes of the apparel with the identified characteristic.

A further aspect of the invention provides a method, comprising: utilizing at least one processor to execute computer code that performs the steps of: identifying a user who is shopping for apparel on an e-commerce website; obtaining at least one image of the user from at least one online source, wherein the at least one image comprises an image showing a characteristic of the user; determining the characteristics of the user by analyzing the at least one image; assigning, based upon the determined characteristic, the user into a group having a plurality of other persons, wherein the plurality of other persons have a characteristic similar to that of the determined characteristic of the user; obtaining a plurality of images and corresponding text for one or more persons of the group of other persons, wherein the plurality of images comprise apparel worn by the other persons in the group; generating apparel rules identifying apparel to be worn by the user having the determined characteristic by mining apparel attributes from the plurality of images and corresponding text; and providing, based upon the generated apparel rules, a recommendation to the user for a piece of apparel based upon the determined characteristic of the user.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of identifying style rules for a characteristic of a user based upon an identified characteristic.

FIG. 2 illustrates an example identification of attributes in a mined image.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

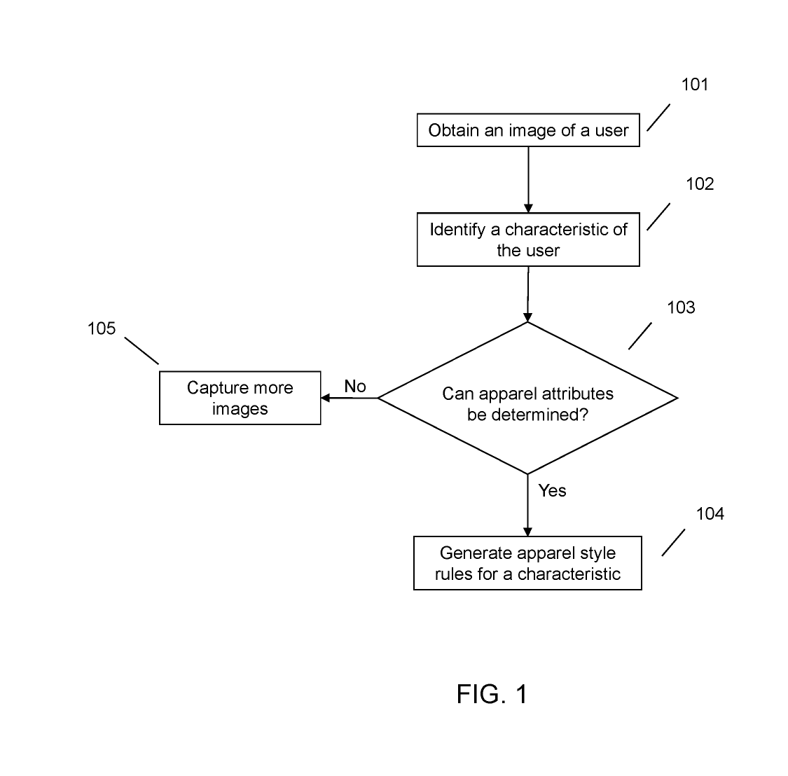

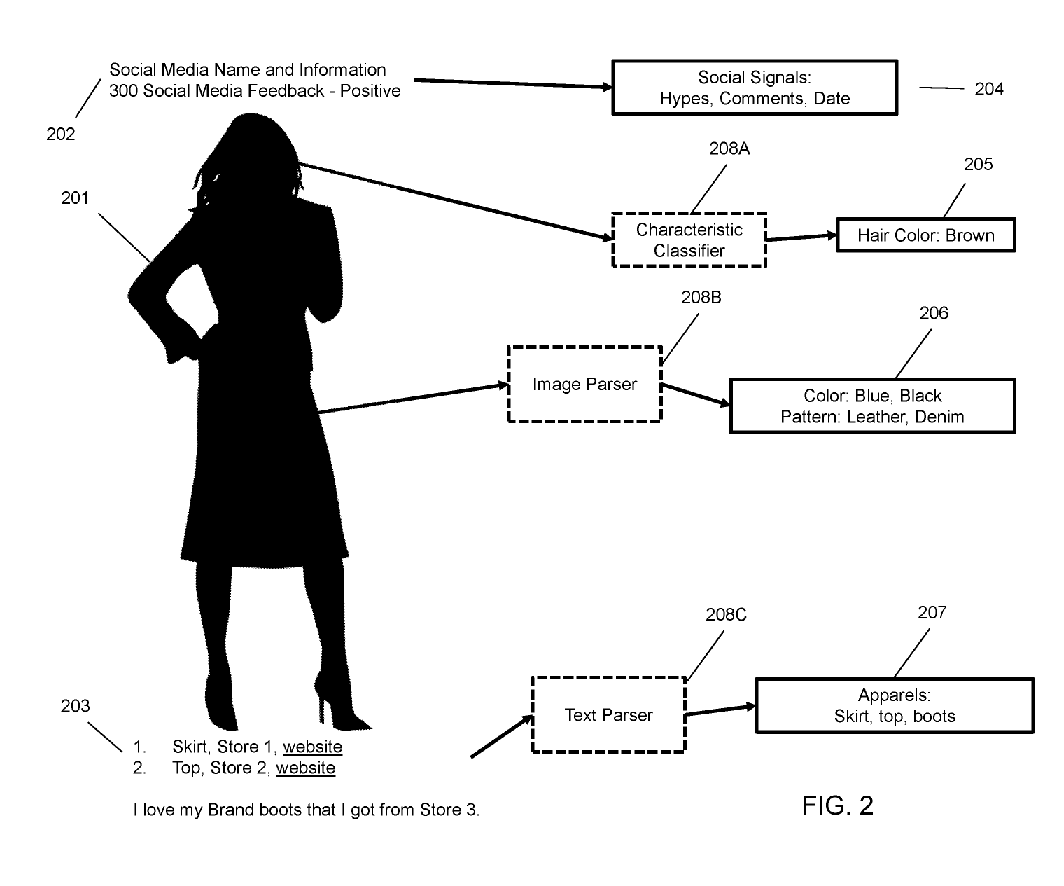

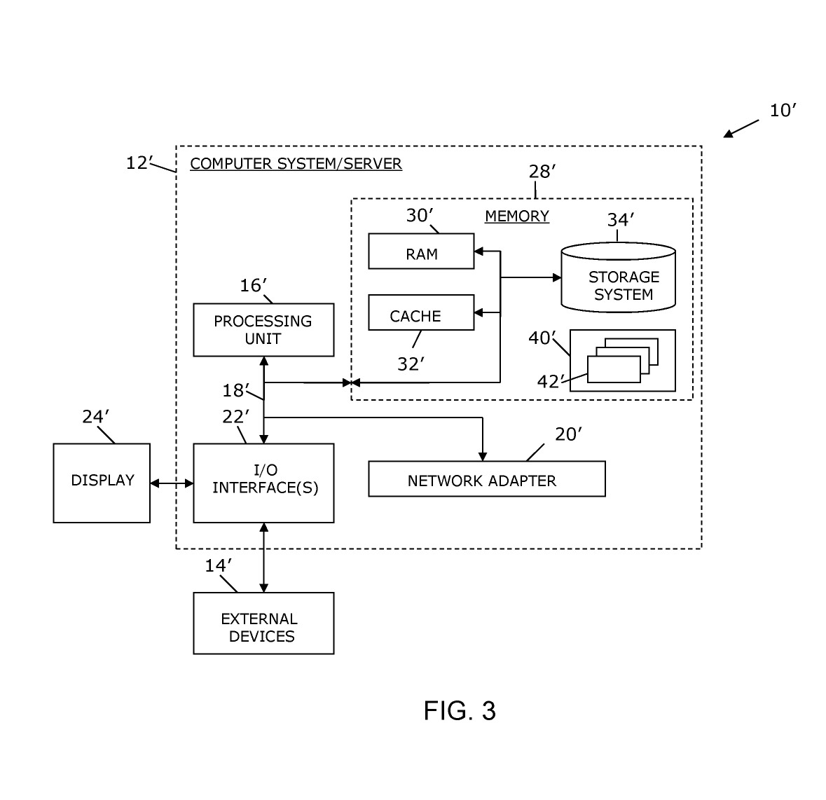

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

Shopping online, rather than in a physical store, is becoming more common due to many factors, for example, more selection online, convenience, locations, and the like. Accordingly, retailers are placing more emphasis on the online shopping experience in an attempt to mimic an in-store shopping experience. For example, the retailers are creating websites intended to more closely mimic the in-store shopping experience. However, online shopping, even with enhanced websites, has drawbacks as compared to the in-store shopping alternative. One problem with shopping in an e-commerce or online store is that the shopper is unable to feel the apparel. Additionally, the shopper is unable to see what the piece of apparel looks like on the person. Thus, online shoppers may only purchase apparel that is known to the shopper, for example, the shopper may have bought the same item previously, may have bought an item having a similar fabric, shape, etc., may have bought a different item but of the same brand, and so on. Alternatively, the shopper may purchase more items than they want, try them on at home once received, and return any items the shopper ultimately did not like or want. Such a process may be very tedious, time consuming, and inconvenient for the shopper.

An additional problem is that a shopper may be unable to determine what would look best on them. Apparel selections and styles changes very frequently, and it may be difficult for a shopper to identify what would look best on them, especially with regard to new styles. Not all fashion trends or styles look the same or even good on people with different characteristics. Looking at a picture of the apparel item may not correctly convey how the piece of apparel will look on the shopper. The retailers may provide pictures of the apparel items on a person. However, that person may not have the same characteristics as the shopper. Accordingly, the shopper is still unable to tell if the apparel item will suit the shopper. In a store, a sales associate may be available to help a shopper determine what styles would look best based upon the shopper's characteristics, but such an associate is unavailable in a virtual shopping environment.

Accordingly, an embodiment provides a method of identifying style rules for apparel based upon identified characteristics. The system may obtain one or more images of a user, for example, from one or more social media websites, the user may upload one or more images, etc. Using these images, the system may identify a characteristic of the user by comparing characteristics of the user to characteristics of other users who are clustered into characteristic groups. The system may parse images of the other users to determine attributes of the apparel worn by or included in the image of the other users. Attributes of the apparel may include fabric type, color, style, and texture. Using these identified attributes, the system may generate apparel style rules for a particular characteristic by associating the attributes with the characteristic. Thus, the system may then determine which apparel types, using the style rules, would suit the target user or shopper.

Such a system provides a technical improvement over current online shopping systems and experiences. The systems and methods as described herein provide a technique for identifying a characteristic of a user and grouping the user with other users having the same or similar characteristics. Using images of the users having the same or similar characteristics, the system may determine attributes of apparel that would be suited for the user. Using the systems and methods as described herein a shopper of an online store is provided a technique for determining if an article of apparel will suit the shopper, even though the shopper is unable to try on the apparel article. Accordingly, the systems and methods as described herein provide a technique for reducing the sometimes time consuming and tedious task of shopping online, trying on the apparel at home, and returning the apparel because it does not suit the shopper. Additionally, the systems and methods as described herein provide a type of online shopping assistant that can help recommend apparel to the shopper, thereby providing an environment more similar to the in-store shopping environment.

Referring now to FIG. 1, at 101, the system may obtain one or more images of a user. Obtaining the image may include requesting the user to upload or identify an image, accessing local data storage for an image, accessing a remote data storage for an image, taking an image using an image capture device, or the like. The system may also obtain the image from one or more social media websites. For example, the system may access a social media website associated with the user and capture or identify an image including the user. As an example, the image may be tagged with the user's name or social media identification/nickname, the image may be included within the user's social media account, etc. For example, the image may include a full-length picture, headshot, and/or an upper torso image.

The image may also include or have associated text. For example, if the image is taken from a social media website, the user or another user may have included a caption providing details about the image. The system may parse the associated text to capture information related to the image or information associated with the user. As another example, the image may be from a video blog and include audio. The system may parse the audio to capture information related to the image. The system may use the associated text to identify different features or attributes about the image. For example, the associated text may identify the person included in the image. The associated text may also be used to identify attributes or features about the person or apparel in the image, as discussed in more detail below.

At 102 the system may use the one or more images of the user to identify a characteristic of the user, for example, hair color, eye color, geographic region, body characteristics, or the like. The characteristic is a general characteristic of the person and may be generally classified based on a characteristic of a user as compared to other physical characteristics. For example, a person having dark hair and dark eyes may be considered as having a winter look. The characteristics may be classified using characteristic standards that are defined by different experts. The system may identify a characteristic of the user by comparing the images of the user to known characteristics. The system may identify characteristics within the image and compare those characteristics to the known characteristics. For example, the system may identify the color of a user's hair by comparing the hair of the user to known hair colors.

The system may also identify the user's characteristic by comparing characteristics of the user, as identified from the one or more images, to characteristics of other users. The other users may be previously clustered into characteristic groups based upon images of the other users. In other words, the other users may already be included in groups based upon the characteristic of the users. Thus, after comparing the user's image to the images of the other users, the system may cluster or group the user into the characteristic group of users having similar characteristics. The system may also use text included or associated with the one or more images, of either the user or the other users, to identify the characteristic of the user. For example, the text associated with the one or more images may include an identified characteristic, a feature for identifying the characteristic, or the like.

The other users may include a designated group of users, for example, the other users may be users who have been identified as apparel experts, trend experts, style experts, trend setters, having good taste in apparel, and the like. These groups of users may then be classified into the characteristic groups. Accordingly, the system may compare the characteristic of the user against characteristics of other users who are considered to have good style sense or are fashion savvy. Grouping the other users into different characteristic groups or categories may be similar to how the user is grouped into different characteristic groups, for example, the system may compare the images of each of the users to characteristic standards or known characteristics.

At 103 the system may determine whether apparel attributes can be determined. Attributes may include different characteristics of apparel, for example, apparel type (e.g., accessory, shoes, top, skirt, etc.), color (e.g., blue, gray, black, etc.), fabric or material type (e.g., denim, suede, leather, etc.), texture (e.g., snakeskin, smooth, ruffles, etc.), print (e.g., plaid, animal print, flowers, etc.), shape or style (e.g., boxy, one-shoulder, pencil skirt, flowy, etc.), and the like. To determine the apparel attributes the system may parse the image and text of the images and associated text of the other users. To identify the attributes, different portions of the image or text may be compared to known attributes. For example, the system may parse the image and compare a texture of a piece of apparel to known textures. As another example, the system may parse text associated with the image and identify different attributes included in the text. The attributes may be specifically denoted in the text, or they may be implied or directed to in the text. For example, the system may include a website linking to the website of the apparel piece. The system may then access that website to identify the attributes of the apparel.

Additionally, the system may determine the apparel attributes based upon a popularity of the style or image. For example, a stylist may create a blog or other social media post including an image of the stylist or other person in an image. Based upon a popularity, for example, as measured using “likes”, “hype”, feedback data, or other social media affinity measurement of the image or style in the image, the system may identify whether the style is good or bad. The system may also use other information within the social media post to identify apparel attributes. For example, the system may determine how “current” the style or apparel is by using a date of the social media post. Since apparel styles change frequently, for example, between seasons, years, months, and the like, a style that was liked or popular at one point, may not be liked or popular at another time. Accordingly, the system may determine how recent the social media post is to determine if the information regarding the apparel is current.

FIG. 2 illustrates an example of a social media post and extracting or identifying attributes from the social media post. An image of the user 201 may be included in the social media post. It should be noted that the image of the user 201 in FIG. 2 is a silhouette image but, in practice, would typically be a full-color image of a user in apparel. The social media post may also include identifying information related to the user, a social media site, a popularity of the image or social media post, and the like 202. The social media post may also include associated text 203, for example, a caption, description of the image, blog related to the user and image, and the like. The associated text may include information related to the apparel included in the image, for example, an attribute of the apparel, website associated with the apparel, and the like.

The system may use different parsers or classifiers, for example, 208A-208C, to identify attributes or features of the image, a user in the image, apparel in the image, and/or the like. For example, the system may use a characteristic classifier 208A to identify the characteristic of the user, for example, in this image, the characteristic of brown hair color 205. As another example, the system may use an image parser 208B to identify different attributes of the apparel, for example, colors: blue and black and pattern: leather and denim 206. It should be noted that because the image is a silhouette, the colors and patterns do not show up in the image. As a final example, the system may user a text parser 208C to identify different attributes of the apparel, for example, apparel types: skirt, top, and boots. The system may also identify social signals 204 from the social media post, for example, in this example, the amount social media feedback, or popularity, other user comments, date of the post, and the like.

Using the apparel attributes and popularity of the social media post, the system can determine if the apparel is popular, well-liked, or a good or bad style. For example, if a particular number of people “like” the social media post, the system may determine that the apparel is a good style. For the system to determine whether a style is good or bad, the popularity may need to reach a predetermined threshold, a predetermined ratio percentage, or the like. As another technique for determining whether a style is good or more, the system may use an attribute of the user who created the social media post. For example, if the user has been identified as a fashion or style expert, the system may identify the apparel in the image as good. In other words, a user may have a rating which determines the quality of the apparel or style in the image.

If apparel attributes cannot be determined at 103, the system may capture more images to try to identify apparel attributes from those images at 105. If, however, apparel attributes can be determined at 103, the system may generate apparel style rules for a particular characteristics at 104. To generate the apparel style rules, the system may frequently mine attributes from different images to be used for generating or updating the apparel style rules. Mining the attributes may occur at predetermined time frames (e.g., as apparel styles change, once a month, etc.) or as new images are uploaded to social media sites.

The apparel style rules may be generated for a particular characteristic by associating the determined attributes with the characteristic of the group. In other words, since the other users have been classified into a characteristic group, the attributes of the apparel worn by those users may be associated with that characteristic group. As an example, the system may determine that a particular color looks good on a person having a particular characteristic. Thus, the style rule may be the color for that characteristic. The apparel style rules may be based upon and generated using any of the attributes that were previously identified or mined, the popularity of the attribute, and the like. For example, an attribute identified as more popular than another attribute may be used for a style rule, while the less popular attribute may not be used for a style rule. Alternatively, the less popular attribute may be used for a negative style rule, for example, a particular attribute does not look good on a person having a particular characteristic.

The style rules may then be used by the system to provide recommendations for the user. The user, who has an identified characteristic as described above, may request recommendations for apparel. These recommendations may be generated using the apparel style rules for that characteristic. For example, the apparel style rules may be used to identify apparel matching the rule and providing the matched apparel to the user as a recommendation. Additionally, the recommendations may be generated as using the style rules as a starting point for the recommendation. For example, the system may identify colors which are similar to a color included in the style rule. The recommendations may also be based in part on user purchase history, price, identified preferences of the user, and the like. For example, the user may have previously identified that the user does not like a particular style rule, so the recommendations may exclude that style rule when generating recommendations for the user.

The style rules may also be used to provide recommendations or feedback to apparel designers. For example, the system may provide the style rules to apparel designers and the apparel designers may use these provided style rules for creating apparel for the identified characteristic. Alternatively, the apparel designers may use the style rules to modify apparel to be better for characteristics that were identified as not matching the apparel. For example, if a style rule identifies a piece of apparel as not being good for a particular characteristic, the designer may redesign the apparel to look better on the characteristic.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
utilizing at least one processor to execute computer code that performs the steps of:
obtaining at least one image of a user of a social medium from one or more posts on the social medium that are shared by the user;
identifying a characteristic of the user by comparing characteristics of the at least one image of the user to other persons, wherein the other persons are clustered into characteristic groups based upon one or more images of each of the other persons;
determining attributes of apparel included in the images of each of the other persons by parsing the one or more images and any text associated with the images of each of the other persons; and
generating apparel style rules for a particular characteristic by associating the determined attributes of the apparel with the identified characteristic.

2. The method of claim 1, wherein the obtaining at least one image comprises accessing a social media account of the user.

3. The method of claim 1, comprising determining the popularity of an apparel type by accessing social signals associated with each of the images of each of the other users.

4. The method of claim 3, wherein the generating apparel style rules is based upon the popularity of an apparel type.

5. The method of claim 1, wherein the generating apparel style rules comprises performing pattern mining on the apparel and the attributes of the apparel.

6. The method of claim 1, comprising providing, using the generated apparel style rules, an apparel style recommendation to the user based on the characteristics of the user.

7. The method of claim 6, wherein the apparel style recommending is based upon identified preferences of the user.

8. The method of claim 1, comprising providing, using the generated apparel style rules, a recommended apparel style for a predetermined characteristic to at least one apparel designer.

9. The method of claim 1, wherein the at least one image of the user comprises text, and wherein the identifying a characteristic is based upon parsing the text and the image of the at least one image.

10. The method of claim 1, wherein the attributes comprise at least one attribute selected from the group consisting of: color, texture, print, type, shape, and material.

11. An apparatus, comprising:
at least one processor; and
a computer readable storage medium having computer readable program code embodied therewith and executable by the at least one processor, the computer readable program code comprising:
computer readable program code that obtains at least one image of a user of a social medium from one or more posts on the social medium that are shared by the user;
computer readable program code that identifies a characteristic of the user by comparing characteristics of the at least one image of the user to other persons, wherein the other persons are clustered into characteristic groups based upon one or more images of each of the other persons;
computer readable program code that determines attributes of apparel included in the images of each of the other persons by parsing the one or more images and any text associated with the images of each of the other persons; and
computer readable program code that generates apparel style rules for a particular characteristic by associating the determined attributes of the apparel with the identified characteristic.

12. A computer program product, comprising:
a computer readable storage medium having computer readable program code embodied therewith, the computer readable program code executable by a processor and comprising:
computer readable program code that obtains at least one image of a user of a social medium from one or more posts on the social medium that are shared by the user;
computer readable program code that identifies a characteristic of the user by comparing characteristics of the at least one image of the user to other persons, wherein the other persons are clustered into characteristic groups based upon one or more images of each of the other persons;
computer readable program code that determines attributes of apparel included in the images of each of the other persons by parsing the one or more images and any text associated with the images of each of the other persons; and
computer readable program code that generates apparel style rules for a particular characteristic by associating the determined attributes of the apparel with the identified characteristic.

13. The computer program product of claim 12, wherein the obtaining at least one image comprises accessing a social media account of the user.

14. The computer program product of claim 12, comprising determining the popularity of an apparel type by accessing social signals associated with each of the images of each of the other users.

15. The computer program product of claim 14, wherein the generating apparel style rules is based upon the popularity of an apparel type.

16. The computer program product of claim 12, wherein the generating apparel style rules comprises performing pattern mining on the apparel and the attributes of the apparel.

17. The computer program product of claim 12, comprising providing, using the generated apparel style rules, an apparel style recommendation to the user based on the characteristics of the user.

18. The computer program product of claim 12, comprising providing, using the generated apparel style rules, a recommended apparel style for a predetermined characteristic to at least one apparel designer.

19. The computer program product of claim 12, wherein the at least one image of the user comprises text and wherein the identifying a characteristic is based upon parsing the text and the image of the at least one image.

20. A method, comprising:
utilizing at least one processor to execute computer code that performs the steps of:
identifying a user who is shopping for apparel on an e-commerce website;
obtaining at least one image of the user from at least one online source, wherein the at least one image comprises an image showing characteristics of the user;
determining the characteristics of the user by analyzing the at least one image;
assigning, based upon the determined characteristics, the user into a group having a plurality of other persons, wherein the plurality of other persons have a characteristic similar to that of the determined characteristics of the user;
obtaining a plurality of images and corresponding text for one or more persons of the group of other persons, wherein the plurality of images comprise apparel worn by the other persons in the group;
generating apparel rules identifying apparel to be worn by the user having the determined characteristic by mining apparel attributes from the plurality of images and corresponding text; and
providing, based upon the generated apparel rules, a recommendation to the user for a piece of apparel based upon the determined characteristics of the user.
